(19) United States
(12) Patent Application Publication
(10) Pub. No.: US 2026/0245008 A1
(43) Pub. Date: Aug. 20, 2026

(54) WORK RECOGNITION SYSTEM AND WORK RECOGNITION METHOD

(71) Applicant: TOYOTA JIDOSHA KABUSHIKI KAISHA, Toyota-shi (JP)

(72) Inventors: Tomohiro MATSUDA, Toyota-shi (JP); Natsuki FUJII, Nagakute-shi (JP); Tomohiro TSUBOTA, Nagoya-shi (JP)

(73) Assignee: TOYOTA JIDOSHA KABUSHIKI KAISHA, Toyota-shi (JP)

(21) Appl. No.: 19/531,800

(22) Filed: Feb. 6, 2026

(30) Foreign Application Priority Data
Feb. 17, 2025 (JP) 2025-023676

(51) Int. Cl. G06Q 10/0631; G06F 3/01; G06V 10/62; G06V 20/40; G06V 20/52

(52) U.S. Cl. CPC G06Q 10/063114; G06F 3/014; G06F 3/017; G06V 10/62; G06V 20/46; G06V 20/52

(57) ABSTRACT

A work recognition system includes: an acquisition unit that acquires sensor data indicating a time-series physical quantity related to an action of an operator; a generation unit that generates event data by extracting a feature portion from the acquired sensor data; and a recognition unit that recognizes a work of the operator by using the event data.

### CROSS REFERENCE TO RELATED APPLICATIONS

This application claims the benefit of priority to Japanese Patent Application No. 2025-23676, filed on February 17, 2025, the entire contents of which are incorporated herein by reference in their entirety.

### BACKGROUND

### Field

The present disclosure relates to a work recognition system and a work recognition method.

### Related Art

Conventionally, technologies are known for recognizing a work which is being performed by an operator, using time-series sensor data. For example, a behavior recognition device disclosed in Japanese Patent Application Publication No. 2020-154552 uses a video as sensor data and generates a recognition dictionary through machine learning by using the video as learning data. The generated recognition dictionary is then used to recognize the behavior of a subject.

However, when the recognition process is performed on all captured videos as in the above-mentioned technology, the processing load may become excessive.

### SUMMARY

The present disclosure can be implemented by having the following aspects.

According to the present disclosure, a work recognition system is provided. The work recognition system includes: an acquisition unit configured to acquire sensor data indicating a time-series physical quantity related to an action of an operator; a generation unit configured to generate event data by extracting a feature portion from the acquired sensor data; and a recognition unit configured to recognize a work of the operator by using the event data.

### BRIEF DESCRIPTION OF THE DRAWINGS

FIG. 1 is a block diagram showing a configuration of a system;

FIG. 2 is a diagram for explaining sensors;

FIG. 3 is a flowchart showing a procedure of a work recognition process;

FIG. 4 is a diagram for explaining glove data;

FIG. 5 is a diagram for explaining Steps S16 and S18;

FIG. 6 is a flowchart showing a procedure of a work recognition process according to a second embodiment; and

FIG. 7 is a diagram for explaining event data in the second embodiment.

### DETAILED DESCRIPTION

### A. First Embodiment:

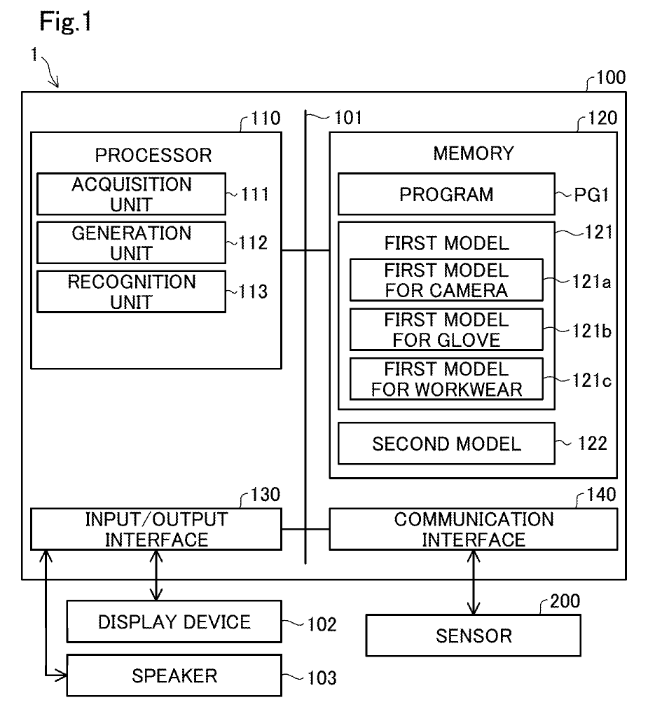

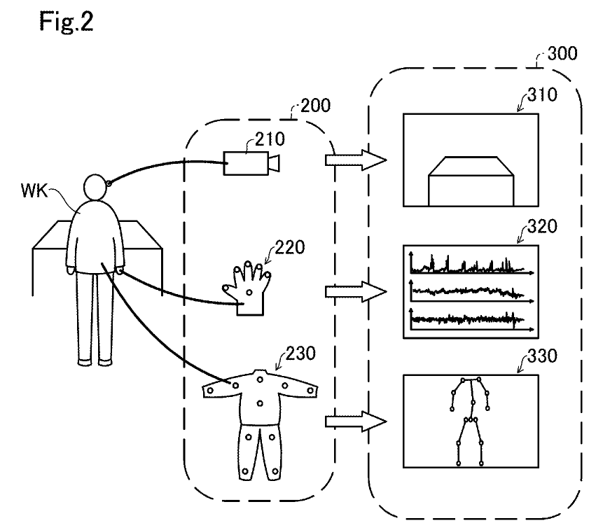

FIG. 1 is a block diagram showing the configuration of a system 1 according to an embodiment. The system 1 includes a work recognition system 100 and sensors 200. The work recognition system 100 uses sensor data 300 (FIG. 2) output from the sensors 200 to recognize a work being performed by an operator WK (FIG. 2). By recognizing the work, which is performed by the operator WK, the system is capable of, for example, evaluating whether the work is being performed in accordance with a manufacturing process.

In the present disclosure, the term “work” includes an action directly related to the manufacturing process and an action indirectly related thereto. Examples of the action directly related thereto include tightening screws, inserting connectors, carrying components and the like. An example of the action indirectly related thereto is moving to a next process.

FIG. 2 is a diagram for explaining the sensors 200. In the present embodiment, the sensors 200 include a plurality of sensor types of sensors. In this disclosure, the classification for the sensor types of the sensors 200 is based on their purpose, rather than on the sensor type of physical quantity detected. Specifically, as the sensors 200, a camera 210 for detecting the operator WK’s field of view as an image, a glove sensor 220 for detecting a hand action of the operator WK, a workwear sensor 230 for detecting a whole-body action of the operator WK, and the like are used. As described later, the glove sensor 220 includes a plurality of sensors for detecting a plurality of sensor types of physical quantities, such as a pressure sensor and an acceleration sensor. In the present disclosure, the camera 210, the glove sensor 220, and the workwear sensor 230 are each treated as a single sensor. As described above, since the purposes of the camera 210, the glove sensor 220, and the workwear sensor 230 differ from one another, the camera 210, the glove sensor 220, and the workwear sensor 230 are of different sensor types. Although various sensors can be used as the sensors 200, the present embodiment exemplifies a case where the sensors 200 include the camera 210, the glove sensor 220, and the workwear sensor 230.

The camera 210 is mounted on the head of the operator WK such that at least a portion of a captured range overlaps the field of view of the operator WK. The camera 210 is also referred to as a First Person View (FPV) camera or a first-person camera.

The glove sensor 220 is a sensor worn on the hand of the operator WK. The glove sensor 220 includes, for example, a pressure sensor, a triaxial acceleration sensor, a triaxial gyroscope sensor, a geomagnetic sensor, and a microphone. These sensors, one or more in number, are attached on a glove worn by the operator WK along the positions of fingertips or the hand skeletons. The combination of the acceleration sensor and the gyroscope sensor is also referred to as an Inertial Measurement Unit (IMU).

The workwear sensor 230 is a sensor worn on the entire body of the operator WK. The workwear sensor 230 includes, for example, a triaxial acceleration sensor and a triaxial gyroscope sensor. These sensors, one or more in number, are attached on the workwear worn by the operator WK along the body skeleton.

The sensor data 300 includes a plurality of pieces of sensor data 300 indicating time-series physical quantities related to the work of the operator WK. In the present embodiment, the sensor data 300 includes camera data 310, glove data 320, and workwear data 330.

The camera data 310 is time-series image data output from the camera 210, that is, video data. The glove data 320 is time-series data output from the glove sensor 220. As described above, the glove sensor 220 includes a plurality of sensors. Therefore, the glove data 320 is, in detail, a collection of data output from the plurality of sensors.

The workwear data 330 is time-series data output from the workwear sensor 230. Note that as described above, the workwear sensor 230 includes a plurality of sensors. Therefore, the workwear data 330 is, in detail, a collection of data output from the plurality of sensors. The workwear data 330 is data output from the sensors attached along the body skeleton of the operator WK. The workwear data 330 is data capable of reconstructing the skeleton of the operator WK through analysis of the workwear data 330. Thus, the workwear data 330 is also referred to as skeleton data.

As shown in FIG. 1, the work recognition system 100 is implemented by a computer including a processor 110, a memory 120, an input/output interface 130, a communication interface 140, and an internal bus 101. The processor 110, memory 120, input/output interface 130, and communication interface 140 are connected via the internal bus 101 to enable bidirectional communication. The memory 120 is implemented by, for example, a RAM or ROM. The input/output interface 130 exchanges data with an external device. The communication interface 140 performs wired or wireless communication with an external device. Specifically, the communication interface 140 performs, for example, LAN communication or short-range wireless communication. The communication interface 140 is implemented by a communication module.

In the present embodiment, data is exchanged between the sensors 200 and the work recognition system 100 through the wired or wireless LAN communication via a communication device (not shown) and the communication interface 140. Note that the communication between the sensors 200 and the work recognition system 100 may also be performed via the input/output interface 130. For example, data exchange between the camera 210 and the work recognition system 100 may be performed through LAN communication via the communication interface 140, or through communication via the input/output interface 130 and a video cable.

A display device 102 and a speaker 103 are connected to the input/output interface 130.

The processor 110 functions as an acquisition unit 111, a generation unit 112, and a recognition unit 113 by executing a program PG1 stored in the memory 120. The acquisition unit 111 acquires the sensor data 300. The generation unit 112 generates event data by extracting a feature portion from the acquired sensor data 300. Here, the term “feature portion” refers to part of data indicating time-series physical quantities for a part of the total data period of the sensor data 300. In the following description, the feature portion may be referred to as an event. As described later, the feature portion is data for a period during which the operator WK is performing a work. The generation unit 112 extracts an event from the sensor data 300 according to a predetermined extraction algorithm. The recognition unit 113 recognizes the work, which is being performed by the operator WK, by using the event data.

In addition to the program PG1, the memory 120 stores a first model 121 and a second model 122. The first model 121 includes a first model 121a for the camera, a first model 121b for the glove, and a first model 121c for the workwear. The first model 121 is a machine learning model for determining a work for the operator WK from the sensor data 300. The first model 121a for the camera is a machine learning model for determining a work for the operator WK from the camera data 310. The first model 121b for the glove is a machine learning model for determining a work for the operator WK from the glove data 320. The first model 121c for the workwear is a machine learning model for determining a work for the operator WK from the workwear data 330.

The first model 121 is a trained machine learning model that has been trained using the sensor data 300. The first model 121 is trained using a learning dataset in which the sensor data 300 and a work label are associated with each other. Examples of the work label include “tightening,” which indicates tightening a screw, “engaging,” which indicates inserting a connector, and the like. When the sensor data 300 is input, the first model 121 outputs a result that associates a determined work label and its probability with time.

The second model 122 is a machine learning model for determining a work for the operator WK by integrating a plurality of results obtained by using the first model 121. By using the second model 122, the work can be inferred in an integrated manner based on the results obtained from the plurality of first models 121 corresponding to the plurality of sensors 200, thereby improving work recognition accuracy. As the first model 121 and the second model 122, for example, a convolutional neural network (CNN) may be used.

In the present embodiment, the work recognition system 100 recognizes the work of the operator WK in real time. This enables comparison with a predetermined manufacturing procedure in real time. When the work being performed by the operator WK differs from the procedure, the operator WK can be alerted, for example, by displaying a warning on the display device 102 or outputting an alert sound from the speaker 103.

As described above, the work recognition system 100 performs data processing on a plurality of pieces of sensor data 300 by using the first model 121. When the work recognition system 100 is implemented on a computer with a low processing speed, work recognition may not be performed in real time. Accordingly, in the present embodiment, the amount of sensor data 300 input in the first model 121 is reduced. This can reduce a processing load of the work recognition system 100.

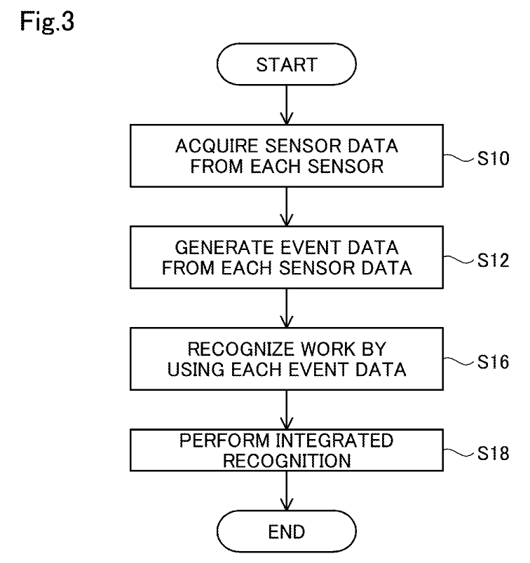

FIG. 3 is a flowchart showing a procedure of a work recognition process performed by the processor 110. A work recognition method is implemented by performing the work recognition process. As shown in FIG. 3, in Step S10, the acquisition unit 111 acquires the sensor data 300 from each sensor 200. Specifically, the acquisition unit 111 acquires the camera data 310 transmitted from the camera 210, the glove data 320 transmitted from the glove sensor 220, and the workwear data 330 transmitted from the workwear sensor 230, and stores them in the memory 120.

In step S12, the generation unit 112 generates event data from the sensor data 300. Here, the event data is data obtained by extracting a period estimated to correspond to a duration in which the operator WK is performing the work. When the operator WK actually performs a work in the manufacturing process, the operator WK takes an action such as walking to check a work location or stopping to look around, during the period between tasks, such as screw tightening. Even if a period during which such an action is performed is excluded from the sensor data 300, the accuracy of work recognition performed by the first model 121 is unlikely to decrease. By using the event data instead of the sensor data 300 as input data to the first model 121, the processing load can be reduced while maintaining the recognition accuracy.

In the present embodiment, for each type of the sensor data 300, namely, for the camera data 310, the glove data 320, and the workwear data 330, an algorithm for extracting events is predetermined. The algorithm for extracting events is stored in the memory 120. Thus, events can be extracted with high accuracy for each sensor data 300.

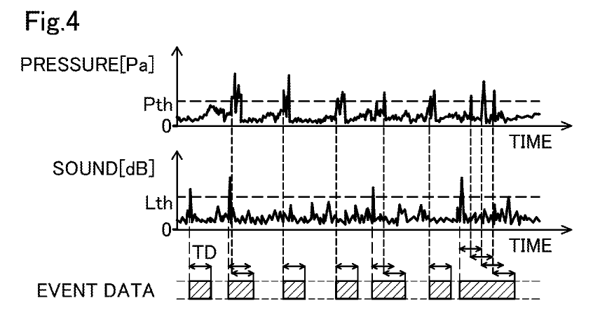

The algorithm for extracting event data will be explained using the glove data 320 as an example. FIG. 4 is a diagram for explaining the glove data 320. Although the glove data 320 includes various types of data such as pressure and acceleration as described above, for ease of understanding, the following description is made by using pressure data and sound data contained in the glove data 320.

The glove sensor 220 is worn on the hand of the operator WK. Thus, for example, when the operator WK grips an object, a detected value of the pressure sensor increases. That is, when the detected value of the pressure sensor increases, it can be determined that the work has started by the operator WK. For example, when the operator WK inserts a connector into a socket to establish a connection, a latch provided on the connector produces a clicking sound as it engages to prevent the connection from being released. Accordingly, when the detected value of the microphone increases, it can be determined that the work has been started by the operator WK. Thus, in the present embodiment, the time when the detected value of the pressure sensor becomes equal to or greater than a predetermined threshold Pth is set as the start time of the event. Similarly, the time when the detected value of the microphone becomes equal to or greater than a predetermined threshold Lth is set as the start time of the event.

In the present embodiment, the end time of the event is set to the time that has elapsed by a predetermined event time TD from the start time of the event. A period indicated by hatching in FIG. 4 represents a period extracted as the event data. The generation unit 112 extracts data from each sensor type of sensor during the period extracted as the event data and generates the event data. The event data is data in which time is associated with a partial sensor data piece extracted from the sensor data 300.

It should be noted that the algorithm for extracting event data is not limited to the above. For example, the end time of an event may be set to a time when the detected value of the sensor becomes smaller than a predetermined threshold. Alternatively, the start time of an event may be set to a time when the detected values of all sensors become equal to or greater than the threshold. Further, instead of the detected values, the amount of change in the detected values may be used to set the start time or end time of an event. Specifically, the start time of an event may be set to a time when the amount of change in the detected value becomes greater than a predetermined reference change amount. Moreover, artificial intelligence (AI) technology may be used to extract event data. Specifically, event data may be extracted using a machine learning model trained with a learning dataset in which the sensor data is associated with a period during which a work has been performed. In general, the extraction process for extracting event data has a lower processing load than the recognition process for recognizing the work.

The generation unit 112 also extracts the event data from the sensor data 300 for the workwear sensor 230 in the same manner as for the glove sensor 220. That is, for each sensor type of sensor included in the workwear sensor 230, the generation unit 112 sets the start time of an event to a time when the detected value becomes equal to or greater than the predetermined threshold. The generation unit 112 sets the end time of the event to a time that has elapsed only by the event time TD from the start time of the event.

The generation unit 112 extracts the event data from the camera data 310 by using the amount of change between frames. Specifically, the generation unit 112 sets the start time of the event to the time when the difference in luminance or luminance histogram between two consecutive frames becomes greater than a predetermined reference difference. The generation unit 112 sets the end time of the event to a time that has elapsed only by the event time TD from the start time of the event.

A method for determining the difference is not particularly limited. For example, for luminance, the average luminance of all pixels in each of the two frames may be determined, and the difference between the averages of the two frames may be determined. Alternatively, the difference in luminance of each pixel between two frames may first be determined, and the average of the obtained differences may then be determined. Alternatively, the difference for only a predetermined portion of an image, rather than the entire frame, may be determined. Alternatively, the generation unit 112 may determine a difference in luminance between two consecutive frames, and when the proportion of an area having the determined difference exceeds a predetermined reference ratio, the generation unit 112 sets this time as the start time of the event.

When performing a next work, the operator WK changes their viewpoint. For example, the operator WK looks around the entire workspace so as to walk toward a workbench. Then, the operator WK looks at the workbench when he/she reaches the workbench. Accordingly, when an image from a view of the entire workspace is changed to an image from a view of the workbench, it can be determined that a work has been started. When the screen changes, the luminance or luminance histogram between two consecutive frames varies. Thus, an event can be extracted by using the amount of change between the frames.

Alternatively, instead of when the image from the entire workspace is changed to the image from the workbench, it may be determined that a work has been started when the image of the workbench continues for a predetermined reference time. This determination utilizes the fact that the operator WK keeps their eye fixed on the workbench while performing the work on the workbench. Specifically, the generation unit 112 sets the start time of an event to a time when a period in which the amount of change between two consecutive frames is smaller than the predetermined reference change amount becomes equal to or greater than a reference period. Further, similar to the glove data 320, the generation unit 112 may also use the artificial intelligence technology to extract event data from the camera data 310.

In Step S16 of FIG. 3, the recognition unit 113 recognizes a work using each piece of event data. Specifically, the recognition unit 113 inputs the camera data 310 to the first model 121a for the camera, thereby obtaining a result of the recognized work. The recognition unit 113 inputs the glove data 320 to the first model 121b for the glove, thereby obtaining a result of the recognized work. The recognition unit 113 inputs the workwear data 330 to the first model 121c for the workwear, thereby obtaining a result of the recognized work.

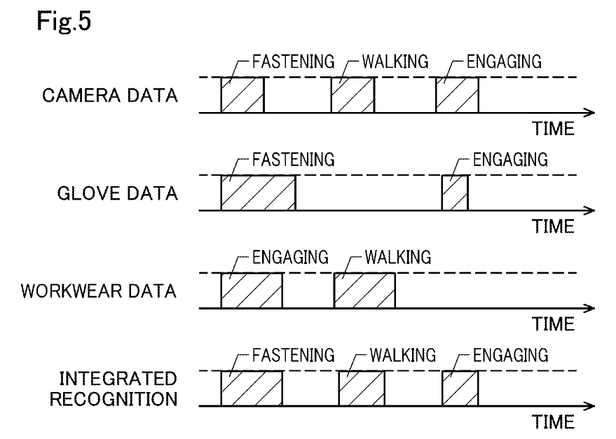

FIG. 5 is a diagram for explaining Steps S16 and S18. In the present embodiment, event data is extracted from each of the camera data 310, the glove data 320, and the workwear data 330. Accordingly, the time periods extracted as event data may not coincide among the multiple sensors. Thus, as exemplified in FIG. 5, a “walking” action recognized using the event data extracted from the camera data 310 may be absent in a work recognized using the event data extracted from the glove data 320. For each event, FIG. 5 shows the work having the highest probability among the probabilities of works obtained as the result of the first model 121. The first model 121 outputs the recognized work in association with a probability. In detail, when the first model 121 recognizes, for one event, multiple works such as “fastening” and “engaging”, it outputs, for example, results such as a probability of 0.6 for “fastening” and a probability of 0.4 for “engaging”.

In Step S18 of FIG. 3, the recognition unit 113 performs integrated recognition using the results of the first model 121 as well as the second model 122. Specifically, the recognition unit 113 inputs the results of the first model 121 into the second model 122 and uses the output result as a final result. “Integrated recognition” in FIG. 5 indicates the result of Step S18. As exemplified in FIG. 5, when both the work recognized using the camera data 310 and the work recognized using the glove data 320 are “fastening”, and the work recognized using the workwear data 330 is “engaging”, the result of the integrated recognition may be “fastening”. Thus, for example, in a case where the correct work is “fastening”, when the work recognized using the workwear data 330 happens to be incorrect, the correct work can be recognized by integrating, with the second model 122, the results of the first model 121 using multiple sensors 200. The inventors have confirmed that the integrated recognition improves the work recognition accuracy.

As shown in FIG. 3, after Step S18 is performed, this processing routine ends. This processing routine is repeatedly executed, for example, as a subroutine of a processing routine that determines whether the work being performed by the operator WK matches a predetermined manufacturing procedure. For convenience of explanation, FIG. 4 shows that the event data includes a plurality of events; however, the event data does not necessarily include a plurality of events. To implement work recognition in real time, this processing routine may be executed, for example, every time at least the event time TD elapses. Further, in order to smoothly extract event data, the extraction of event data in Step S12 and the recognition of the work in and after Step S16 may be performed in parallel.

In the above description, a case has been explained in which this processing routine is used in processing for determining whether the work being performed by the operator WK matches the predetermined manufacturing procedure. This processing routine can be used, for example, to train the operator WK to memorize the manufacturing procedure and to evaluate the operator WK’s proficiency.

In the above description, a case has been exemplified in which the sensors 200 include the camera 210, the glove sensor 220, and the workwear sensor 230. The sensor types of sensors included in the sensors 200 are not limited to those described above. For example, the sensors 200 may include a sensor for detecting a position of the operator WK and a microphone for detecting the operator WK’s voice or ambient sounds. The sensors 200 are not limited to those worn by the operator WK. For example, the sensors 200 may be a camera that captures an image of the operator WK or a sensor attached to a tool.

The camera 210 is also referred to as a first sensor, and the camera data 310 is also referred to as first sensor data. The glove sensor 220 is also referred to as a second sensor, and the glove data 320 is also referred to as second sensor data. Event data generated from the camera data 310 is also referred to as first event data. An extraction algorithm for extracting a feature portion from the camera data 310 is referred to as a first extraction algorithm. Event data generated from the glove data 320 is also referred to as second event data. An extraction algorithm for extracting a feature portion from the glove data 320 is referred to as a second extraction algorithm.

According to the first embodiment described above, the work recognition system 100 includes the acquisition unit 111, the generation unit 112, and the recognition unit 113. The generation unit 112 generates event data by extracting a feature portion from the sensor data 300 acquired by the acquisition unit 111. The recognition unit 113 recognizes a work, which is being performed by the operator WK, by using the event data. Since the recognition unit 113 recognizes the work using event data, which has a smaller data amount than the sensor data 300, the recognition unit 113 can reduce the processing load performed by the work recognition system 100.

The acquisition unit 111 acquires a plurality of pieces of sensor data 300. The generation unit 112 generates a plurality of pieces of event data from the plurality of pieces of sensor data 300. The recognition unit 113 performs integrated recognition to recognize the work using the plurality of pieces of event data. Consequently, the recognition accuracy can be improved, as compared to a case where the work is recognized using only one piece of event data.

For each piece of sensor data 300, the acquisition unit 111 generates event data using a corresponding extraction algorithm. Thus, since the extraction algorithm suitable for each piece of sensor data 300 can be used, the feature portion can be extracted with high accuracy.

### B. Second Embodiment:

In the above-described embodiment, the start time of an event is individually set for each of the plurality of pieces of sensor data 300. In the present embodiment, the generation unit 112 generates event data for one of the plurality of pieces of sensor data 300 by using a predetermined extraction algorithm. Subsequently, the generation unit 112 generates event data for another piece of sensor data 300 by using the start time of the event of the event data generated previously. Components and processing steps identical to those in the first embodiment are denoted by the same reference numerals, and detailed descriptions thereof are omitted where appropriate.

In the present embodiment, a case will be explained in which the sensor data 300 for setting the start time of an event is the camera data 310. The sensor data 300 for setting the start time of an event is referred to as the first sensor data.

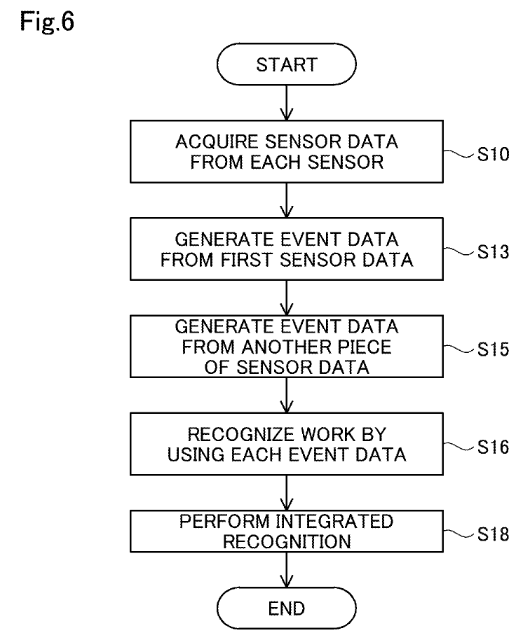

FIG. 6 is a flowchart showing a procedure of a behavior recognition process according to the present embodiment. As shown in FIG. 6, in Step S10, the acquisition unit 111 acquires the sensor data 300 from the sensors 200. In Step S13, the generation unit 112 generates event data from the camera data 310, which is the first sensor data, similarly to the first embodiment.

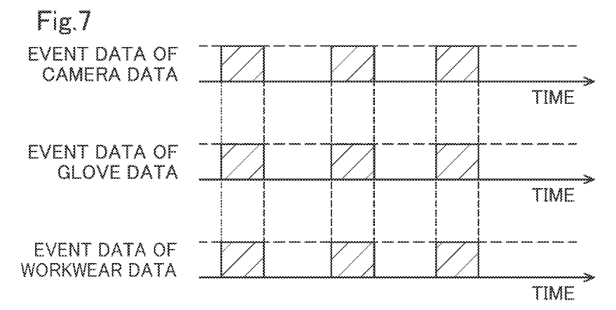

In Step S15, the generation unit 112 generates event data from another piece of sensor data 300, excluding the first sensor data. Specifically, the generation unit 112 extracts a time-series physical quantity for the same period as the feature portion of the sensor data, namely, the camera data 310, which is the first sensor data, and generates event data in each of the glove data 320 and the workwear data 330. In detail, the generation unit 112 uses the event start time and the event end time of the event data extracted in Step S13 to generate event data in each of the glove data 320 and the workwear data 330. FIG. 7 is a diagram for explaining event data in the present embodiment. Hatched portions shown in FIG. 7 represent extracted events.

When the operator WK starts a work, he/she often changes their gaze. Therefore, when the operator WK starts a work, this is highly likely to be extracted from the camera data 310 as the event. Accordingly, even when event data for another piece of sensor data 300 is extracted using the event data in the camera data 310, the work can be extracted without omission.

In Step S16 of FIG. 6, the recognition unit 113 recognizes a work using each piece of event data. In Step S18, the recognition unit 113 performs integrated recognition using the results of the first model 121 and the second model 122.

According to the second embodiment described above, in Step S13, the generation unit 112 generates the event data using the camera data 310. In Step S15, the generation unit 112 extracts, from the glove data 320 and the workwear data 330, time-series physical quantities for the same period as the feature portion of the sensor data of the camera data 310, and generates respective pieces of event data for the glove data 320 and the workwear data 330. Thus, for the sensor data 300 other than the camera data 310, the processing load of the generation unit 112 can be reduced because the event data are generated by extracting the time-series physical quantities for the same period as the feature portion of the camera data 310.

### C. Other Embodiments:

(C1) In the first embodiment described above, the recognition unit 113 recognizes a work by using the first model 121, which uses a plurality of pieces of event data, and then further recognizes the work by using the results of the first model 121 and the second model 122. In another embodiment, the recognition unit 113 may recognize the work by using event data generated from a single piece of sensor data 300, and this result may be used as the final result. Even in a case where a single piece of event data is used to obtain the final result, the processing load can still be reduced because the event data having a reduced amount of data is used instead of the entire sensor data 300.

(C2) In the second embodiment described above, the event data generated first is the event data of the camera data 310. The sensor data 300 from which the event data is generated first is not limited to the camera data 310. The sensor data 300 from which the event data is generated first is preferably data from the sensors 200 capable of detecting all of the works performed by the operator WK without omission.

The present disclosure is not limited to the above-described embodiments and may be implemented in various modifications without departing from the spirit of the disclosure. Unless the technical feature is described herein as essential, it can be deleted as appropriate. For example, the present disclosure may be implemented in the manner described below.
(1) According to a first aspect of the present disclosure, a work recognition system is provided. The work recognition system includes: an acquisition unit configured to acquire sensor data indicating a time-series physical quantity related to an action of an operator; a generation unit configured to generate event data by extracting a feature portion from the acquired sensor data; and a recognition unit configured to recognize a work of the operator by using the event data. According to this aspect, the event data used by the recognition unit is data about a partial period of the entire data period of the sensor data, whereby the amount of data is reduced compared to that of the sensor data. Therefore, the processing load performed by the recognition unit can be reduced.
(2) In the work recognition system of the above-described aspect, the sensor data includes first sensor data detected by a first sensor and second sensor data detected by a second sensor having a sensor type different from that of the first sensor, the generation unit generates first event data from the first sensor data and second event data from the second sensor data, and the recognition unit recognizes the work by using the first event data and the second event data. According to this aspect, since the recognition unit can recognize the work by using the first event data and the second event data which are of different types, the recognition accuracy can be improved.
(3) In the work recognition system of the above-described aspect, the generation unit generates the first event data from the first sensor data by using a first extraction algorithm and generates the second event data from the second sensor data by using a second extraction algorithm, and the first extraction algorithm extracts a first feature portion from the first sensor data and the second extraction algorithm extracts a second feature portion from the second sensor data. According to this aspect, when the event data of the first sensor data is generated, the first extraction algorithm appropriate for the first sensor data is used, whereas when the event data of the second sensor data is generated, the second extraction algorithm appropriate for the second sensor is used, so that the feature portion can be extracted with high accuracy.
(4) In the work recognition system of the above-described aspect, the generation unit generates the first event data from the first sensor data by using a first extraction algorithm and generates the second event data by extracting, as the feature portion, a time-series physical quantity of the second sensor data for the same period as a period of the feature portion of the first event data, and the first extraction algorithm extracts the feature portion from the first sensor data. According to this aspect, the generation unit generates the event data for the second sensor data by extracting the time-series physical quantity of the second sensor data for the same period as the feature portion of the first sensor data, thereby enabling a reduction in the processing load on the generation unit.
(5) In the work recognition system of the above-described aspect, the first sensor may be a camera that is set such that at least a portion of a captured range overlaps a field of view of the operator.
(6) In the work recognition system of the above-described aspect, the second sensor may be a sensor worn on a hand of the operator and configured to detect an action of the hand of the operator.

The present disclosure may be implemented in various forms, in addition to a work recognition system, such as a work recognition method, a control method for the work recognition system, a computer program for executing the control method, and a non-transitory tangible recording medium storing the computer program.

What is claimed is:

1. A work recognition system, comprising:
an acquisition unit configured to acquire sensor data indicating a time-series physical quantity related to an action of an operator;
a generation unit configured to generate event data by extracting a feature portion from the acquired sensor data; and
a recognition unit configured to recognize a work of the operator by using the event data.

2. The work recognition system according to claim 1, wherein
the sensor data includes first sensor data detected by a first sensor and second sensor data detected by a second sensor having a sensor type different from that of the first sensor,
the generation unit generates first event data from the first sensor data and second event data from the second sensor data, and
the recognition unit recognizes the work by using the first event data and the second event data.

3. The work recognition system according to claim 2, wherein
the generation unit generates the first event data from the first sensor data by using a first extraction algorithm and generates the second event data from the second sensor data by using a second extraction algorithm, and
the first extraction algorithm extracts a first feature portion from the first sensor data and the second extraction algorithm extracts a second feature portion from the second sensor data.

4. The work recognition system according to claim 2, wherein
the generation unit generates the first event data from the first sensor data by using a first extraction algorithm and generates the second event data by extracting, as the feature portion, a time-series physical quantity of the second sensor data for the same period as a period of the feature portion of the first event data; and
the first extraction algorithm extracts the feature portion from the first sensor data.

5. The work recognition system according to claim 2, wherein the first sensor is a camera that is set such that at least a portion of a captured range overlaps a field of view of the operator.

6. The work recognition system according to claim 5, wherein the second sensor is a sensor worn on a hand of the operator and configured to detect an action of the hand of the operator.

7. A work recognition method, comprising:
acquiring sensor data indicating a time-series physical quantity related to an action of an operator;
generating event data by extracting a feature portion from the acquired sensor data; and
recognizing a work of the operator by using the event data.
